(19) United States
(12) Patent Application Publication
(10) Pub. No.: US 2010/0199587 A1
(43) Pub. Date: Aug. 12, 2010

(54) WINDOW CONSTRUCTION AND ASSEMBLY SYSTEM

(76) Inventor: Salvador Mateu Climent, Valencia (ES)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/677,556

(22) PCT Filed: Sep. 10, 2008
(86) PCT No.: PCT/ES2008/000584

§ 371 Date: Mar. 11, 2010

(30) Foreign Application Priority Data
Sep. 11, 2007 (ES) P 200702428

(51) Int. Cl. E06B 3/10; E04B 1/66

(52) U.S. Cl. 52/515; 52/656.5

(57) ABSTRACT

The invention relates to a window construction and installation system, including: glued laminated wood profiles (1) forming the vertical parts or jambs (1a) and the horizontal parts (1b) upper lintel and lower sill, of the frame (or pre-frame, where appropriate); profiles (2) forming the vertical parts or posts (2a) and the horizontal parts or transoms (2b) of the leaf or leaves; and profiles (3) forming pane-separating bars, all of which are suitably finished, even with paint and/or varnish, and dimensioned to be 10 or 15 cm longer than required, having only one of the ends thereof machined, finished with a chamfer (4), with mortises (5) and attachment tenons (6) and dowels (7), keys or with a detachable spline or wedge (8), leaving the opposite end as is, ready for in situ assembly once the exact size of the opening or reveal is known.

### OBJECT OF THE INVENTION

As expressed in the title of this specification, the invention relates to a window construction and assembly system, providing the function for which it is intended with several advantages and innovative features, which will be described in detail below.

More specifically, the object of the invention consists of a construction system for all types of window, particularly wood windows, having both the frame and the leaf disassembled, and prepared such that they can be assembled in situ very simply and to the exact measurement of the opening or reveal.

Likewise, the invention contemplates the combination of different materials for the leaf and for the frame, such that wood is only used for the leaf whereas the frame can be of any inorganic material with higher resistance to the inclemency of the weather.

### FIELD OF APPLICATION

The field of application of the present invention is comprised within the construction industry.

### BACKGROUND OF THE INVENTION

As is known, windows, traditionally made in wood, are increasingly being replaced by windows made in metal or PVC, due to the versatility and lower cost offered by said materials, however, they will never substitute the advantageous features of insulation, warmth, versatility and aesthetics which wood can offer.

The problem lies in the fact that, up until now, wood windows come already assembled, but due to their complex constitution and their adaptation to the specific measurements of each construction they become a high-cost element since said dimensions are always variable and it is not possible to make standard measurements which can reduce said costs.

It is therefore necessary to create a construction and assembly system which allows making windows, particularly wood windows, at a cost competitive with that of other materials, this being the main objective of the present invention, which proposes as a solution to said problem the advantageous possibility of making windows in situ, allowing their adaptation to the exact measurement of the opening or reveal in each case.

It must also be indicated that currently and as a reference to the state of the art, the applicant does not know of the existence of any other window construction and assembly system having technical, structural and configuration features similar to those of the system proposed herein.

### DESCRIPTION OF THE INVENTION

Thus, the window construction and assembly system proposed by the present invention is configured by itself as an evident novelty within its field of application, since, according to its creation, any type of window (hinged window, pivot-hung window, tilt and turn window, sliding window or skylight) is made in a specific manner in the actual site, thus providing a series of advantages which puts it on a level with or makes it surpass windows made on other materials.

Thus, the main advantage of the system of the invention is given by the accuracy and ease of insertion, which is achieved from the window. In addition, and not less important, is the ease in transport and storage achieved, as well as the reduction of costs due to the smaller space that it occupies, and the possibility of making and finishing the profiles in series, even with paint and varnish, which profiles will only be partially machined to procure their assembly on site.

To that end, and more specifically, the window construction and assembly system proposed by the invention consists of using wood profiles, preferably glued laminated wood profiles, which will have the suitable thickness and shape for the formation of the different parts forming frames and leaves, being able to given them the desired shapes, even being already painted and/or varnished, and about 10 to 15 cm longer than required.

Said profiles will, in a characterizing manner, at one of their ends, be finished with a chamfer, with conventional mortises and attachment tenons, with dowels, wedges, splines, pins or keys, leaving the opposite end as is, so that the operator finishes it, carrying out its construction and assembly, in situ and once the exact size of the opening or reveal is known.

The windows can thus be served disassembled, with all the advantages that this entails in transport and handling, furthermore covering a large part of the market of customized wood windows, currently being difficult and expensive to supply.

Continuing with the invention, and optionally, the use of different materials for the leaf and for the frame is contemplated. Thus, preferably, the frame (always towards the exterior) will be of metal, PVC or any other suitable inorganic material and the leaves of wood.

Several objectives are thus achieved, facilitating, improving the preservation and extending the service life of the window:
Inorganic materials are easier to treat than wood.
Inorganic materials withstand the inclemency of the weather better than wood, with smaller or even nil contractions and expansions.
The frames, due to their location towards the exterior, when they are at a height, have a subsequent treatment with a more difficult access than the leaves, which can be worked on from the interior.
Inorganic materials are usually more cost-effective than wood.
The mortises and tenons, as well as any other connection, are worked on better with inorganic materials than with wood.
The insulation, warmth and aesthetics offered by wood are conserved. The frame can be treated, imitating wood.
The frames of inorganic material can be placed during the construction process of the work, since they withstand better the aggressive treatment that they undergo during this period.

The new window construction and assembly system therefore represents an innovation of structural and constitutive features unknown up until now for such purposes, which reasons, added to its practical usefulness, provided it with sufficient grounds to obtain the exclusive right which is sought.

### DESCRIPTION OF THE DRAWINGS

To complement the description that is being made and for the purpose of aiding to better understand the features of the invention, a set of drawings is attached to this specification as an integral part thereof, in which the following has been depicted with an illustrative and non-limiting character:

FIG. 1 shows a schematic view of the assembly of the profiles forming the parts which will form the frame and the leaves of the window, according to the system object of the invention, the attachment between the already machined and finished ends thereof and the lack of finish of their opposite ends being seen.

FIG. 2 shows a detailed view of an example of attachment between chamfered parts with mortise and tenon.

FIGS. 3 and 4 respectively show respective detailed views of other examples of attachment between chamfered parts with dowels or keys of solid wood and with a detachable spline or wedge.

### PREFERRED EMBODIMENT OF THE INVENTION

In view of the mentioned figures, and according to the adopted numbering, a preferred embodiment of the invention can be observed therein, which comprises the parts and elements, which are indicated and described in detail below.

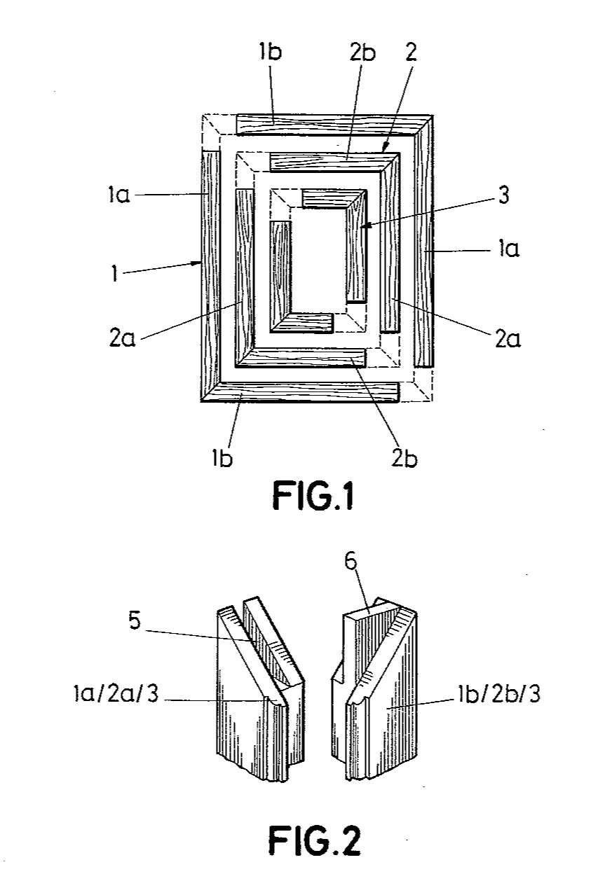

Thus, as seen in FIG. 1, the system in question comprises, for the construction and assembly of wood windows, the use of glued laminated wood profiles (1) forming the vertical parts or jambs (1a) and the horizontal parts (1b), i.e., upper lintel and lower sill, of the frame (or pre-frame, where appropriate), glued laminated wood profiles (2) forming the vertical parts or posts (2a) and the horizontal parts or transoms (2b) of the leaf or leaves, and glued laminated wood profiles (3) forming the pane-separating bars or strips, which will be suitably finished, each according to its application, even with paint and/or varnish, being dimensioned to be slightly longer, by between 10 and 15 cm, than required.

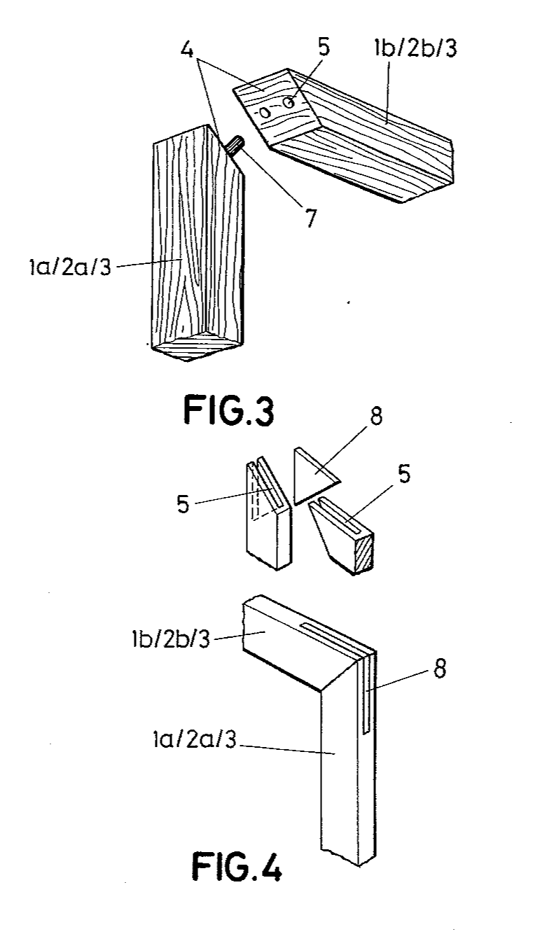

Each of said profiles (1, 2 and 3) has, only at one of its ends, the machined finish, always with a chamfer (4), which can be, as seen in the examples depicted in FIGS. 2 to 4, with mortises (5) and attachment tenons (6) (FIG. 2), with dowels (7) or keys of solid wood (FIG. 3), or with a detachable spine or wedge (8).

Thus, the assembly of the corresponding vertical and horizontal adjacent parts of each element of the window, i.e., the frame, the leaves, the bars, etc., is prepared to be directly assembled, leaving the opposite end of the profiles as is, so that the operator finishes it, carrying out its construction and assembly, in situ and once the exact size of the opening or reveal is known (FIG. 1).

Optionally, the use of different materials for the leaf and for the frame is contemplated.

Preferably, the frame will be of metal, PVC or any other suitable inorganic material and only the leaves of wood.

Having sufficiently described the nature of the present invention, as well as the way to put it into practice, it is not considered necessary to extend its explanation for any person skilled in the art to understand its scope and the advantages derived therefrom, stating that, within its essence, it may be put into practice in other embodiments which differ in detail from the one indicated by way of example, and which will also be covered by the protection which is claimed provided that its fundamental principle is not altered, changed or modified.

1. A window construction and assembly system, particularly for wood windows, characterized in that it comprises the use of glued laminated wood profiles (1) forming the vertical parts or jambs (1a) and the horizontal parts (1b), including upper lintel and lower sill, of the frame, glued laminated wood profiles (2) forming the vertical parts or posts (2a) and the horizontal parts or transoms (2b) of the leaf or leaves, and glued laminated wood profiles (3) forming the pane-separating bars or strips, which will be suitably finished, each according to its application; wherein each of said profiles (1, 2 and 3) has only one of its ends finished and machined, with mortises (5) and attachment tenons (6), with dowels (7) or keys of solid wood, or with a detachable spline or wedge (8), such that the assembly of the corresponding vertical and horizontal adjacent parts of each element of the window, including frame, leaves, and bars, is prepared to be directly assembled, leaving the opposite end of the profiles as is, ready for in situ assembly once the exact size of the opening or reveal is known.

2. The window construction and assembly system according to claim 1, characterized in that the profiles (1, 2 and 3) are, prior to their assembly, finished even with paint and/or varnish.

3. The window construction and assembly system according to claims 1 and 2, characterized in that the profiles (1, 2 and 3) are dimensioned to be slightly longer, by between 10 and 15 cm, than required.

4. The window construction and assembly system according to claims 1 to 3, characterized in that, optionally, the use of different materials for the leaf and for the frame is contemplated, the frame preferably being of metal, PVC or any other suitable inorganic material and only the leaves of wood.
